(19) United States
(12) Patent Application Publication
(10) Pub. No.: US 2018/0055722 A1
(43) Pub. Date: Mar. 1, 2018

(54) ORTHOPAEDIC DEVICE

(71) Applicants: Shane Patrick Murnaghan, Dublin (IE); Pearl Limited, Chester (GB)

(72) Inventor: Shane Patrick MURNAGHAN, Dublin (IE)

(21) Appl. No.: 15/555,716

(22) PCT Filed: Mar. 7, 2016
(86) PCT No.: PCT/EP2016/054809

§ 371 Date: Sep. 5, 2017

(30) Foreign Application Priority Data
Mar. 5, 2015 (GB) 1503764.1

(51) Int. Cl. A61H 11/00; A61H 15/00; A61H 7/00

(52) U.S. Cl. CPC A61H 11/00; A61H 2201/169; A61H 7/001; A61H 2201/1284; A61H 2201/1609; A61H 2201/1623; A61H 2201/1628; A61H 2205/04; A61H 2201/1635; A61H 2201/164; A61H 2201/165; A61H 2205/102; A61H 2205/081; A61H 2205/088; A61H 15/00

(57) ABSTRACT

The present invention relates to a massage device comprising: a support, and a plurality of massage elements, each projecting a distance outwardly from the support and having a rounded massaging surface, characterised in that at least some of the massage elements project outwardly from the support by a first distance, and at least others of the massage elements project outwardly from the support by a second distance, whereby the first and second distances are different. The present invention provides a massage device comprising a massage surface consisting of closely packed massage elements set at different heights. The massage elements are provided by hemispheres each having a rounded upward facing massage surface, that interface with the skin to trigger a powerful unwind and relaxation response from the strained area of contact and peripheral to it. The device is a passive massage device without moving parts.

The present invention relates to a massage device.

Known massage devices utilise human assisted manual movement, passive binding based operations or electrical motor assistance to move tissue in random directions to help create a stretched environment. Such devices may, with persistence and luck, help to unlock a strain via random alignment of the tissue with the needed vector of force to elicit a release of the route of strain. Such devices do not however predictably find the direction of counter-strain.

There are also devices that use elements which are adhered to the skin in order to conduct an electrical impulse there through to trigger a twitch mechanism to thereby move a tissue structure back to its normal length and operational status without discomfort.

There are also tools moulded out of wood, plastic, glass or metal which, in use, attempt to simulate finger action and are used manually to move the muscle tissue in hope of saving the operator strain on their hands whilst alleviating strain associated discomfort for the recipient.

The problems with the above devices and approaches to massage include that they typically involve massaging indiscriminately. Deep tissue massage is also known to cause the recipient pain.

It is a therefore an object of the present invention to provide a massage device which goes at least some way toward overcoming the above problems and/or which will provide the public and/or industry with a useful alternative.

Further aspects of the present invention will become apparent form the ensuing description which is given by way of example only.

According to the invention, there is provided a massage device comprising:
a support, and
a plurality of massage elements, each massage element comprising a rounded massaging surface and projecting a distance outwardly from a side of the support,
characterised in that at least some of the massage elements project outwardly from the support by a first distance, and at least others of the massage elements project outwardly from the support by a second distance, whereby the first and second distances are different.

In another embodiment of the invention, each massage element is shaped as a hemisphere.

In another embodiment of the invention, the massage elements are hemispherical in shape, and a curved surface thereof provides the rounded massaging surface of each massage element.

In another embodiment of the invention, the distance a massage element projects outwardly from the support is the length of the radius or height of the hemisphere shape.

In another embodiment of the invention, each massage element comprises a substantially flat base for engaging with the support and a curved surface operable as the rounded massaging surface.

In another embodiment of the invention, the distance a massage element projects outwardly from the support is the length from the centre of the flat base to the top most point relative to the flat base of the curved surface.

In another embodiment of the invention, the massage elements are arranged substantially adjacently and packed closely together on the support.

In another embodiment of the invention, at least some of the massage elements project outwardly from the support by a third distance, whereby the first, second and third distances are different.

In another embodiment of the invention, the first distance is greater than second distance, and the second distance is greater than the third distance.

In another embodiment of the invention, the first, second and third distances are each in the range of 2 mm to 20 mm.

In another embodiment of the invention, the massage elements are arranged in rows on the support.

In another embodiment of the invention, the massage elements are arranged in a plurality of rows on the support, and each massage element in a row extends one of: the first, second or third distance from the support.

In another embodiment of the invention, the massage elements are arranged in rows on the support, and a position of a massage element in a row is determined by the distance that the massage element projects from the support.

In another embodiment of the invention, the support is substantially planar and operable to provide a flat substantially rigid mounting for the massage elements.

In another embodiment of the invention, the support is substantially triangular in plan view.

In another embodiment of the invention, the support comprises first and second support members, and each support member comprises a plurality of integrally formed outwardly projecting massage elements.

In another embodiment of the invention, the support members are integrally formed.

In another embodiment of the invention, the support members are separate members and connect via connection means to form the support.

In another embodiment of the invention, one of the support members is softer relative to the other of the support members.

In another embodiment of the invention, the massage elements formed on one of the support members are relatively softer than the massage elements formed on the other of the support members.

In another embodiment of the invention, the support is provided by a pad or a mat.

In another embodiment of the invention, the pad or mat is releasably connectable to a neck supporting cradle.

In another embodiment of the invention, the neck supporting cradle comprises a substantially U-shaped mounting surface for the pad.

In another embodiment, the cradle comprises a convex shaped mounting surface for the pad and a pivot member is provided at a base of the cradle about which the cradle may pivot or rock when in use.

In another embodiment of the invention, the support is provided by a flexible strap or wrap to which the massage elements are mounted.

In another embodiment of the invention, the flexible strap or wrap comprises a closure means to enable the support to be releasably secured to a wearer.

In another embodiment of the invention, the massage elements are made of wood, plastic, glass or like materials. For example, the massage elements may be made of a rubber material, such as a silicone rubber.

In another embodiment of the invention, the support is made of a plastic material, such as neoprene, rubber or silicone rubber.

The present invention provides a massage device comprising a massage surface consisting of massage elements provided by hemispheres having a rounded upward facing massage surface, that interface with the fascia of the skin when offered up, triggering a powerful unwind and relaxation response from the strained area of contact and peripheral to it.

The massage surface is mounted on a support, which may be one of a triangular mould for the sacrum; a pad or mat which connects with a curved neck cradle for the neck; and a flexible neoprene backed fabric applicable to other areas of the body.

The sacral mould and the neck-cradle versions provide close support to the skin surface unique to the body offering close support and relief. The advantages of the present invention include that the surface works uniquely in so far as it calibrates to the skin senses in a way that unwinds strain patterns without pain.

The massage elements gently push the surface of the skin in many directions, closely replicating the phenomenon of close packing, offering the ligaments and tendons many directions to unwind without pain.

The advantages of the invention are that, it does not require prolonged usage or lengthy massage techniques to achieve its effect. The present invention is a passive stationary device that is used pro-actively to assure good movement and balance prior to activity. The present invention may be used to re balance the structure to help unwind strain and reduce discomfort.

The present invention is lightweight and portable and requires no assistance to use, allowing privacy and instant availability when desired. The present invention may help mentally relax the user due to its association with the vestibular system and anxiety potentials in the user.

The present invention thus provides a passive massage device for unwinding stressed ligaments and tendons at the joints in humans. The device is made up of hemisphere shaped massage elements that are attached to, and closely packed on, a support. The support may be a semi-elastic flexible backing material that is moulded to the strained stiff joint with the help of a pre moulded shell or wrapped in place with an elastic bandage where necessary to hold the massage device in place compressed against the skin.

The present invention is a massage device operates like a ‘skin’ that when wrapped around or closely compressed to a stiff or strained joint, or strained ligament or tendon, creates a proprioceptive feedback phenomenon that releases strain unilaterally to the area due to the deformation of the strain pattern by the skin reacting on a central nervous system level to being compressed by multiples of hemispheres stretching their points of contact unilaterally.

The present invention can be fitted into a mould of a joint or body landmark, and the massage surface comprising tightly packed hemisphere shaped massage elements is compressed against the joint to be treated. The massage device, in use, dynamically passively stretches the area in all directions at a subcutaneous level stimulating the proprioceptors.

The present invention due to its proprioceptive stimulating nature is a pro-active, passive, massage surface that is applicable to various joint and ligament sites throughout the body including Apo neurosis and ligamentum nuchae where present in humans and animals.

The present invention is a massage device that utilises the central nervous system and vestibular system and acts as a triggering device to the proprioceptors of skin tendons muscles and capsular ligaments respond to via vestibular stimulation and re-integration.

The present invention is a message device that is used passively by the user by either lying down on it using their own body weight when required, or wearing it as part of a compression garment backed with an elasticated fabric to apply the invented surface pressure towards the skin.

This present invention is operable to work on the proprioceptor network of ligaments and tendons throughout the whole body, neck and the sacrum of the human spine. The unwind it stimulates allows the full spinal mechanism unwind to such an extent, it resets the orthopaedic mechanisms

The present invention may be used separately, on mounts, or may be applied to various human joint wraps, which when used, unwind stressed ligaments and tendons at the joints, to assist better recovery from strained tissue. In particular the present invention relates to an adaptable massage device, comprising of, hemi-spherically shaped closely packed massage elements, on a pliable, rigid, or flexible elastic base, which in use, unwinds strain out of body tissue.

The present invention uses its surface as a subtle stimulation to the Somesthesia feedback network in the fascia of the user's muscular physiology.

The present invention utilises the Somesthesia effect on the area of the body it is applied to, it has a broad release effect on the user. It can be used on all joints, such as the forearm, wrist, elbow, knee, hip, back, pelvis and neck. This allows lesser strains to unwind effectively and return the user to a safe walking gait.

The present invention when used creates a stretch effect via compression against the skin due to the multi spherical shape of the surface. Via the many hemispheres in its matrix, it multiplies its omnidirectional stretch phenomenon enhancing the release on a much deeper parasympathetic and proprioceptive system response.

The present invention addresses the unnecessary need to massage indiscriminately without a plan. Using the device prior to massage allows the operator to enhance the treatment as the orthopaedic model of balance is already reset. By usage the proprioceptor system has already been re-calibrated allowing greater freedom of movement and vestibular stimulation.

The present invention is shaped for the neck or the sacrum and works gently and passively without further massage requirements by the operator. By proper placement of the device under or around the affected area provides for excellent transmission of the effect provided by the device due to the motion of the body at rest and the compressive surface at work.

The present invention eliminates the unwanted pain of deep tissue massage. General health massage requires specific pressures and motion based on the unique physiology of the user, and not brute force from a strong massage practitioner or machine, the invention when used is unlocking the route of strain passively.

The present invention overcomes problems with prior art devices and provides a solution to general injury strain management due to the manner in which it enables a user to use their own central nervous system's innate sensitivity, and its innate proprioceptive feedback mechanisms that are throughout the body.

The close compression provided by the massage elements at the surface of the invention is applied to the strained area of the body and is deployed, together with, the compressive force that unwinds the strain at the point of contact.

The present invention is usable on the exterior skin surface of the human body. It may also be used on animals when provided as a wrap.

The present invention provides a unidirectional, untwisting, spreading effect, of the user's skin on a minute scale when pressed on the matrix of the surface provided by the massage elements which causes a swirling unwind of the strained tissue. The release of the strain when using the present invention in a specific shape, at a sacral level allows deep fascia release which in turn allows basic gait theory to take over from strain allowing the user ease of walking and greater flexibility.

The device can be moulded of lightweight plastic or dense rubber including flexible materials with specific density. The use of the device as the interface in specific moulds has excellent results on neck strain.

The invention may be used as a wrap around a strained joint and is secured with elastic bandage, elasticated adhesive dressing, or attached Velcro strips that are adjustable for comfort.

The support of the present invention may be made of neoprene, or other material, as a backing with hemispheres attached to one side of the backing material. The massage elements may be made of wood or plastic with a glass like hardness. The massage elements may be made of a rubber material, such as a silicone rubber. The massage elements are bunched together in ‘close packing’ formation.

The invention will hereinafter be more particularly described with reference to and as shown in the accompanying drawings which show by way of example only one embodiment of a receptacle for cremated remains according to the invention. In the drawings:—

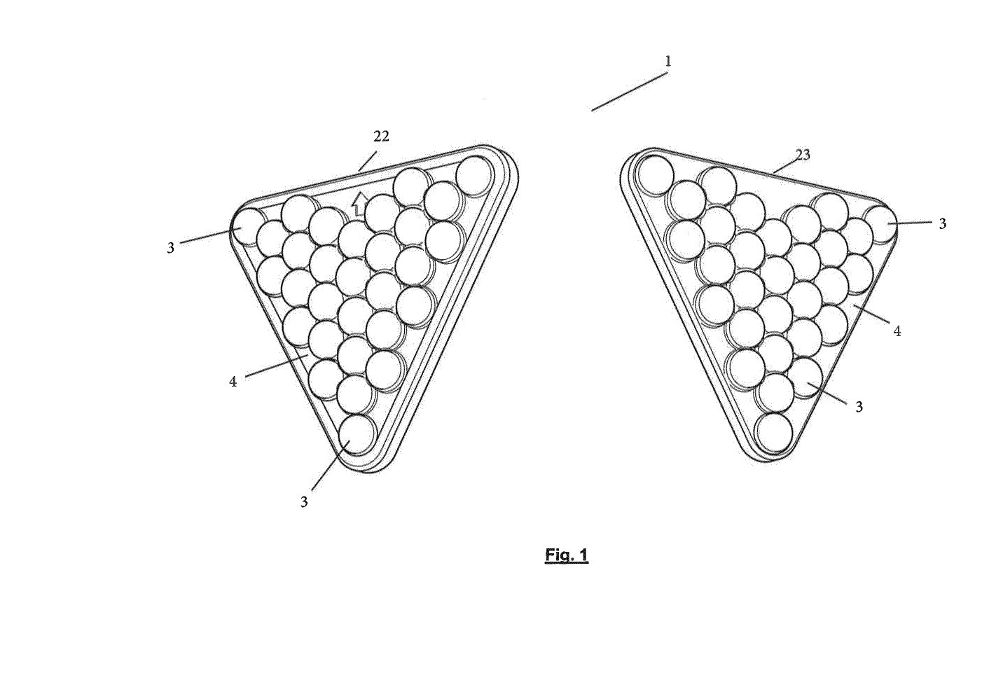

FIG. 1 is a perspective view of an embodiment of a massage device in accordance with the invention;

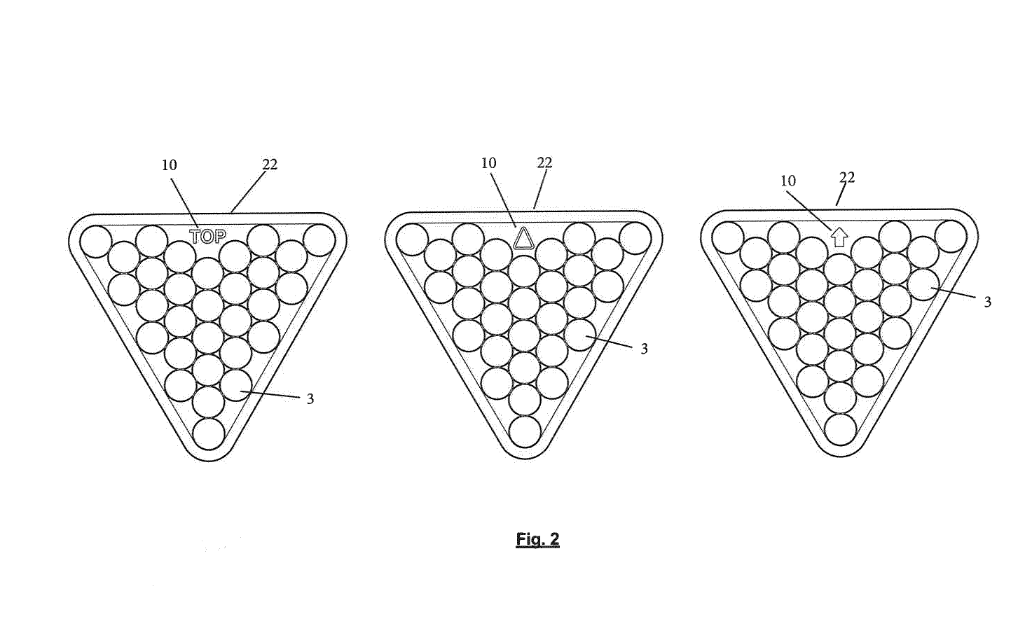

FIG. 2 are top views of the massage device shown in FIG. 1;

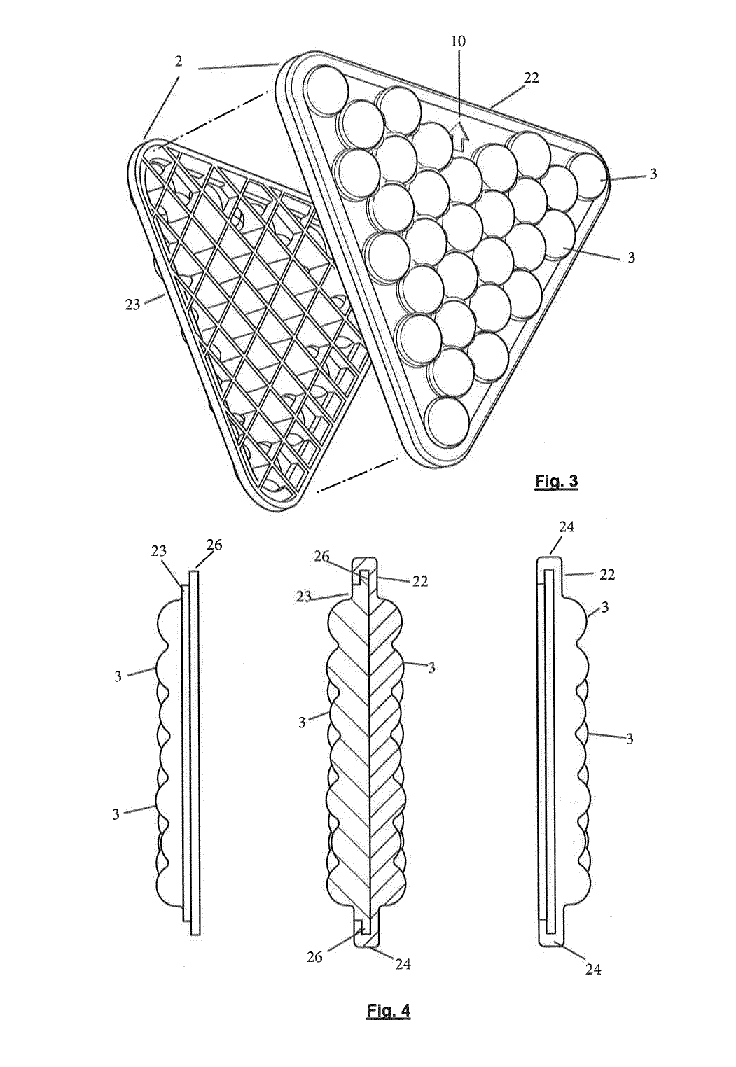

FIG. 3 is a perspective view showing support members of the massage device in accordance with the invention;

FIG. 4 are sectional views showing interconnected support members of the massage device in accordance with the invention;

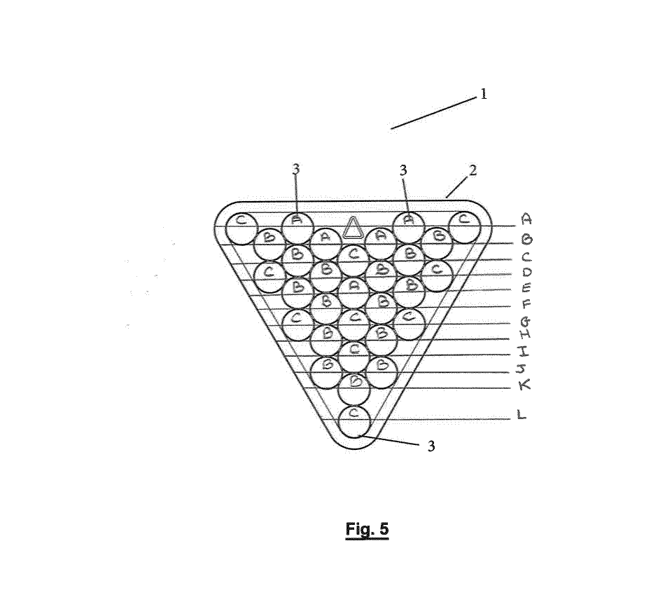

FIG. 5 is a schematic showing an arrangement of massage elements in a massage device according to a further embodiment of the invention.

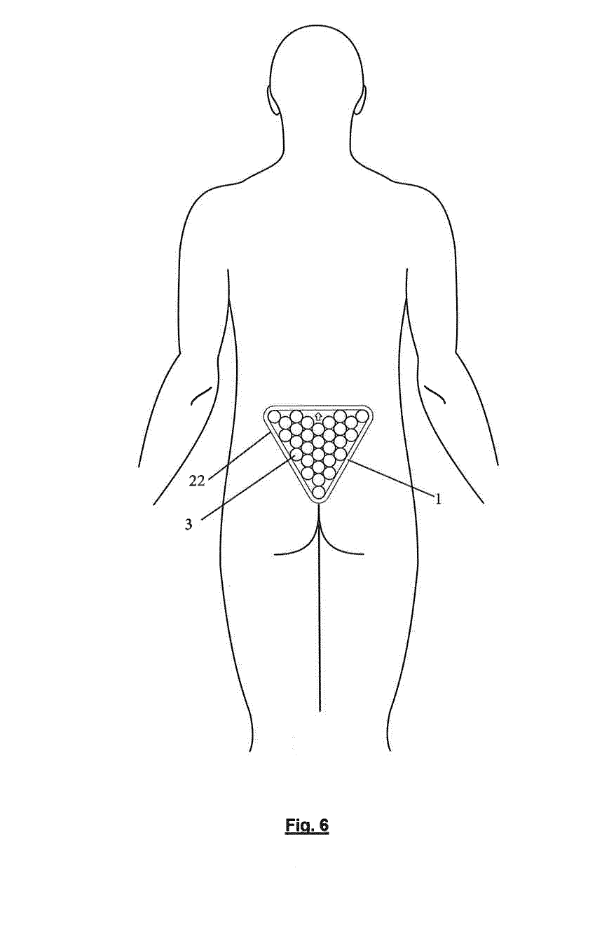

FIG. 6 is a plan view showing the massage of FIGS. 1 to 5 in use;

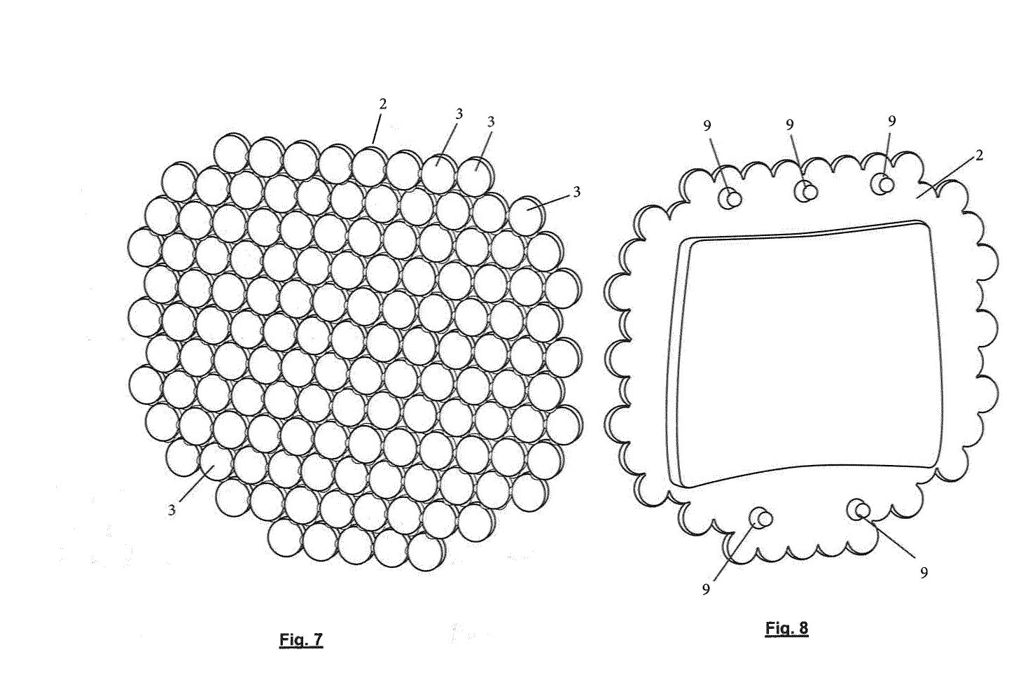

FIGS. 7 and 8 are perspective views of a massage mat for use in connection with further embodiment of a massage device in accordance with the invention;

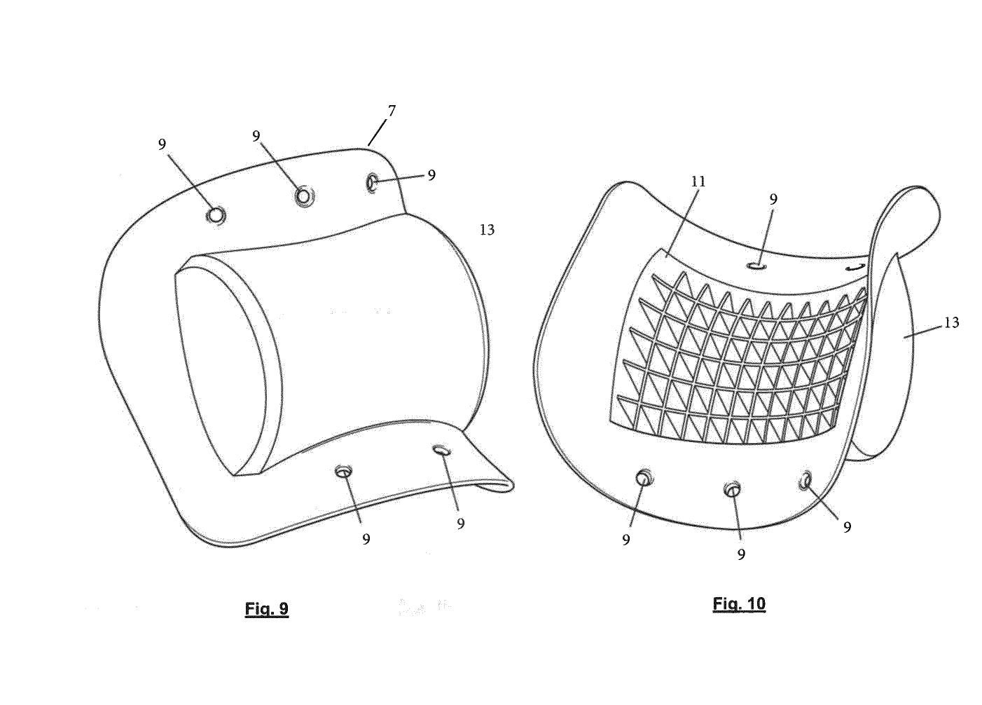

FIGS. 9 and 10 are perspective views of a cradle operable with the massage mat shown in FIGS. 7 and 8;

FIG. 11 is a perspective view showing a massage device in accordance with a further embodiment of the invention;

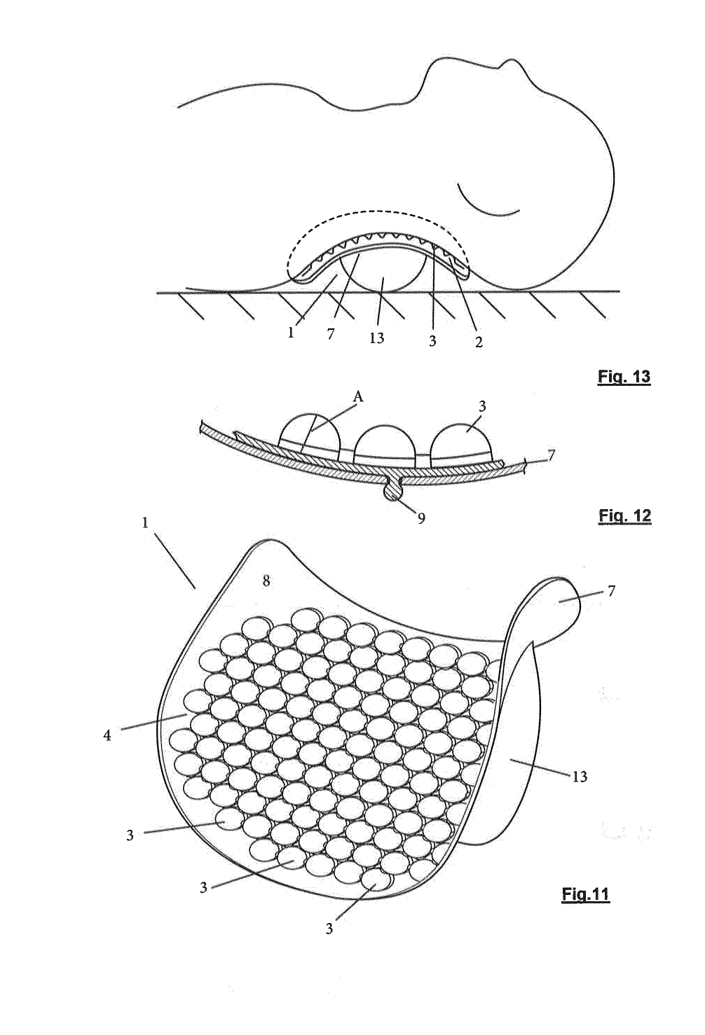

FIG. 12 is a side sectional view of the massage device shown in FIG. 11;

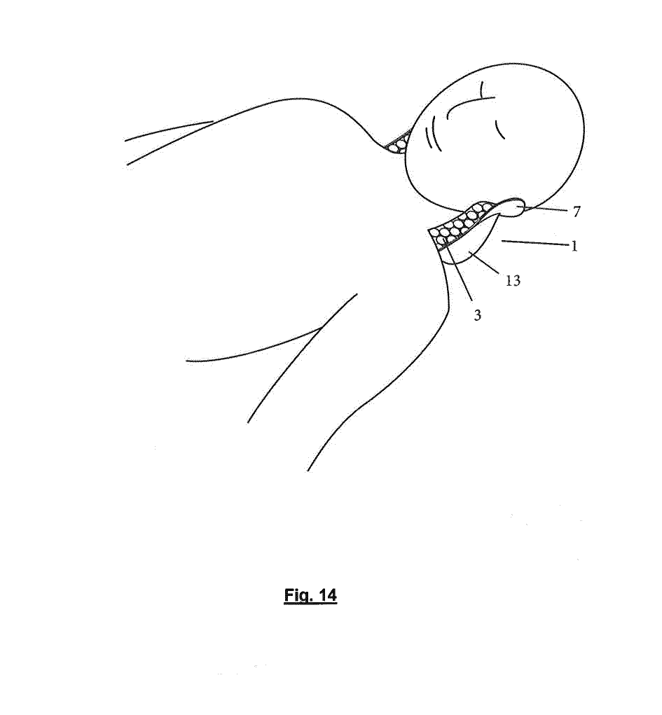

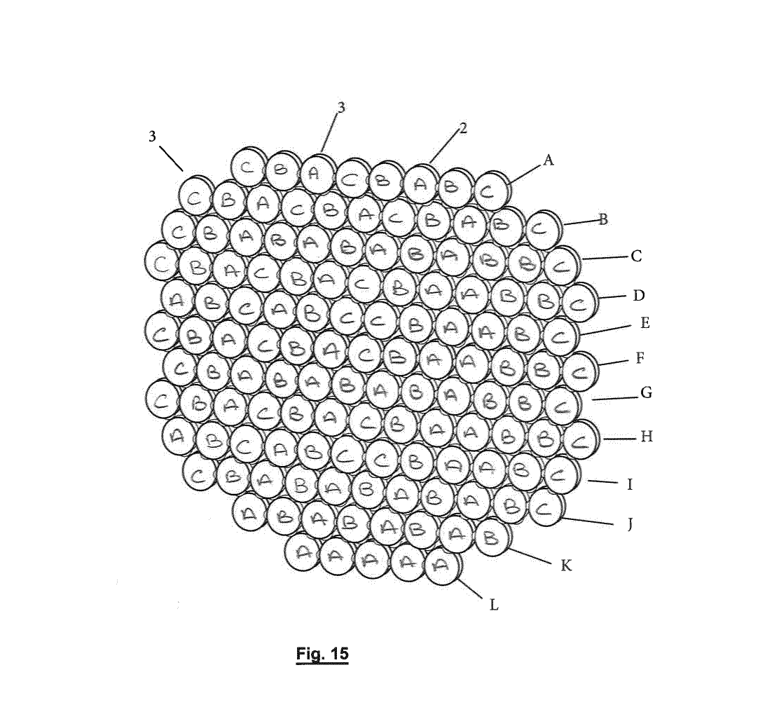

FIGS. 13 and 14 are side views of the massage device shown in FIG. 11 in use; and

FIG. 15 is a schematic showing an arrangement of massage elements in a massage device according to an embodiment of the invention.

Referring to the drawings, and initially to FIGS. 1 to 6, there is shown a massage device, indicated generally by the reference numeral 1, comprising a support 2 and a plurality of massage elements 3. Each massage element 3 projects a distance, indicated by the arrow ‘A’ (see FIG. 12) outwardly from the support 2, and has a rounded massaging surface 4. The massage elements are made of wood, plastic, glass or like relatively hard materials.

In the instance shown, each massage element 3 is shaped as a hemisphere, and the curved outer surface 4 of the hemisphere shape provides the rounded massaging surface of each massage element 3. In such an embodiment it will be understood that the distance ‘A’ that a massage element 3 projects outwardly from the support 2 is the length of the radius or the height of the hemisphere shape. Each massage element 3 therefore comprises a substantially flat base 5 for engaging with an upper surface of the support 2 and a curved surface operable as the rounded massaging surface 4. The distance a massage element 4 projects outwardly from the support is also computed as the length from the centre of the flat base 5 to the highest point 6 relative to the flat base of the curved surface 4. Each hemisphere is 2 mm to 20 mm in diameter, and preferably, 15 mm in diameter.

It will be understood that the massage elements 3 may be integrally formed with the support 2, or may be separately formed and connected to the support 2 using a connection means, such as a glue, Velcro™, clips or other connectors. The massage elements 3 are arranged substantially adjacently and are packed closely together on the support 2.

The support is optionally made of a plastics material, such as neoprene, or other suitable plastics or a fabric with similar elasticity. The massage elements 3 may be positioned on the support 2 in either a side by side adjacent arrangement, or at 45 degree angles to each other, retaining a consistent close packing formation.

The support 2 of the present invention may be shaped and dimensioned as required or as desired depending on the location of the body that the massage device 1 is to be used on.

The support 2 may be substantially triangular in plan view, as shown in FIGS. 1 to 6, and provide a mounting for the massage elements 3. In such an embodiment, the support is substantially planar and operable to provide a flat substantially rigid mounting for the massage elements 3. The triangular support 2 includes an arrow 10 pointing up engraved into the support 2 to indicate the correct orientation of the massage device in use. The bottom corner may have an arrow pointing down. FIG. 2 shows different options regarding the style and type of arrow 10 pointing up engraved into the support 2. The word “top” may also be engraved.

The support 2 comprises a first and second support members 22, 23, and each support member 22, 23 comprises a plurality of integrally formed outwardly projecting massage elements 3. The support members 22, 23 are separate members and interconnect via connection means to form the support. One of the support members 22, 23 comprises an overlap or locking member 24 formed at an edge or along the perimeter thereof which folds over an edge 26 of the other support member 22, 23 so that the two support members 22, 23 are connected to form the massage device 1.

In the embodiment shown, the support member 22 comprises the locking member 24 which is operable to fold over an edge 26 of the support member 23 to thereby lock the two support members 22, 23 together. In such an embodiment, the support member 22 is made of material that is softer relative to the material of the other support member 23 to enable it to fold over the perimeter edge of the support member 23. The integrally formed massage elements 3 of the support member 22 are also softer relative to the massage elements 23 on the other support member 23.

Reference will now be made to FIG. 5 in which a specific implementation of the present invention are described. As shown, the massage elements 3 are arranged in a plurality of rows on the support 2, and each massage element 3 in a row extends one of: the first, second or third distance from the support 2. The specific arrangement shown is exemplary only, and should in no way be seen as limiting.

As shown in FIG. 5, the massage elements 3 are arranged in a plurality of rows on the support 2, and each massage element 3 in a row extends one of: the first, second or third distance from the support 2. The arrangement of massage elements is shown on the triangular mounting, which in the specific arrangement shown, there are also twelve rows of hemispheres shown on the triangular support 2, these are shown by the reference letters ‘A’ to ‘L’. Each row comprises a number of massage elements 3, and in the example shown, there are five in row ‘A’, four in row ‘B’, three in row ‘C’, four in row ‘D’, three in row ‘E,’, two in row ‘F’, three in row ‘G’, two in row ‘H’, one in row ‘I’, two in row ‘J’, one in row ‘K, and one in row ‘L’.

In the example, the height or distance that a massage element 3 projects from the triangular support surface 2 is shown by the references A, B or C, in which A indicates a massage element height of 12 mm, B a height of 11 mm and C a height of 10 mm. From left to right, as shown in FIG. 5, Column A is sequenced CAAC; Column B is sequenced BAAAB; Column C is sequenced BCB; Column D is sequenced CBBC; Column E is sequenced BAB; Column F is sequenced BB; Column G is sequenced CCC; Column H is sequenced BB; Column I is sequenced C; Column J is sequenced BB; Column K is sequenced B, and Column L is sequenced C.

In the arrangement shown the massage elements 3 that are centrally located on the support 2 are higher than those massage elements near the perimeter of matrix of massage elements.

FIG. 6 shows the device in the embodiments shown in FIGS. 1 to 5 for use on the sacrum of a human body, which is the bony structure above the coccyx in the middle of the posterior pelvis between the left and right gluteus maximus muscles below the end of the back. In use, a user may place the massage device 1 under the sacrum and lie on the device 1. The device 1 may be oriented such that the massage elements 3 of either the support member 22 or the support member 23 are upward facing and so engage against the sacrum depending on the whether they want a soft surface or a firm surface for a better penetrating release depending on how strained the sacrum is.

Accordingly, depending on the intended use, the massage device 1 may be oriented such that the softer massage elements 3 of the support member 22 engage against the human body, in which arrangement, the massage elements 3 of the support member 23 are downward or ground facing. Conversely, the massage device 1 may be oriented such that the relatively firmer or harder massage elements 3 of the support member 23 instead engage against the human body, in which arrangement, the relatively softer massage elements 3 of the support member 22 are downward or ground facing.

Turning now to FIGS. 7 to 14, the support 2 may alternatively be provided as a pad or a mat 6, in which the pad or mat 6 is releasably connectable to a neck supporting cradle 7 using connector means 9. As shown, the neck supporting cradle 7 comprises a substantially U-shaped mounting surface 8 to which the pad or mat 6 may be connected. The neck cradle 7 includes a recessed region 11 to assist in fitting the mat or pad 2 to the cradle 7. The word “top” may be engraved into the neck cradle 7 above the recessed pattern 11 so as to assist with the fitting of the mat 2 for the users. The provision of a neck cradle comprising a U-shaped neck receiving region 8 enables the massage device 1 to be applied to the back of the neck whilst the patient lies down on it. A rocker element or pivot in the form of padding or cushioning 13 is provided at the back of the cradle 7. The cradle 7 has a natural curve of the cervical spine and back and sides of the neck that is used with the invention surface.

The cradle 7 may be a one piece plastic moulded integrally formed structure. The upper sides of the neck cradle 7 fit snugly to the sides of the user's base bones of the head and the ligament area at the back of the neck along with the tendons that invest into the back of the head. The cradle 7 curves transversely superiorly and anteriorly in a three dimensional shell like curved structure. The neck cradle 7 is tapered from the top to the bottom to provide a fit for the base of the skull which is greater that the width of the base which nestles into the back of the neck.

In another embodiment, the support 2 is provided by a flexible strap or wrap to which the massage elements 3 are mounted. Such a flexible strap or wrap comprises a closure means to enable the support 2 to be releasably secured to a wearer. For example, the support 2 comprising the massage elements 3 may be applied to the inside of a gauntlet or glove, which may be closed around a hand so that the massage device 1 may be fitted to the human wearer. Straps or Velcro may assist in fitting the glove or gauntlet. The invention surface constantly unwinds the tension as the user is wearing the glove or gauntlet. The massage device 1 may also be applied to or provided as a wrap for application to a knee or ankle or other part of the body. When positioned against the knee, the invention surface engages the knee muscles and stimulates the relaxation required to release the strain pattern of the knee effecting the hamstrings, Sartorius muscle, anterior Tibialis and the Quadriceps tendon, the Popliteus muscle posteriorly and the lateral ilio tibial band.

The massage elements 3 are set at a plurality of different heights so that the rounded massage surface 4 of some of the massage elements 3 mounted to the support 2 project higher or lower from the support 2 than others. Accordingly, at least some of the massage elements 3 project outwardly from the support 2 by a first distance, at least others of the massage elements 3 project outwardly from the support by a second distance, and some of the massage elements 3 project outwardly from the support by a third distance whereby the first, second and third distances are different. The first distance may be greater than second distance, and the second distance may be greater than the third distance so that the massage elements 3 are set at three different heights form the support 2. The heights at which the massage elements 3 are set may in the range of 2 mm to 20 mm from the support surface 2.

Although reference will be made to the present invention having massage elements 3 set at or extending outwardly at two or three different heights from the support, this should in no way be seen a limiting. Accordingly, it will be understood that the present invention foresees implementations in which the massage elements 3 may be set at one, two, three, four, five or more different heights or distances from the support. Different settings for height or distance that the massage elements 3 extend from the support surface 2 are also envisaged and reference to a range of 2 mm to 20 mm should in no way be seen a limiting.

Reference will now be made to FIG. 15 in which a specific implementation of the present invention are described. As shown, the massage elements 3 are arranged in a plurality of rows on the support 2, and each massage element 3 in a row extends one of: the first, second or third distance from the support 2. The specific arrangement shown is exemplary only, and should in no way be seen as limiting.

In the specific arrangement shown, there are twelve columns of hemispheres shown on the support mat 2, these are shown by the reference letters ‘A’ to I′. Each row comprises a number of massage elements 3, and in the example shown, there are eight massage elements 3 in row ‘A’, eleven in row ‘B’, twelve in row ‘C’, thirteen in row ‘D’, twelve in row ‘E,’, thirteen in row ‘F’, twelve in row ‘G’, thirteen in row ‘H’, twelve in row ‘I’, eleven in row ‘J’, eight in row ‘K, and five in row ‘L’.

In the example, the height or distance that a massage element 3 projects from the support surface 2 is shown by the reference A, B or C, in which A indicates a massage element height of 12 mm, B a height of 11 mm and C a height of 10 mm.

From left to right, as shown in FIG. 15, Column A is sequenced CBACBABC; Column B is sequenced CBACBACBABC; Column C is sequenced CBABABABABBC; Column D is sequenced CBACBACBAABBC; Column E is sequenced ABCABCCBAABC; Column F is sequenced CBACBACBAABBC; Column G is sequenced CBABABABABBC; Column H is sequenced CBACBACBAABBC; Column I is sequenced ABCABCCBAABC; Column J is sequenced CBABABABABC; Column K is sequenced ABABABAB, and Column L is sequenced AAAAA.

It is to be understood that the invention is not limited to the specific details described herein which are given by way of example only and that various modifications and alterations are possible without departing from the scope of the invention as defined in the appended claims.

1. An orthopaedic device comprising:
a support, and
a plurality of massage elements, each massage element comprising a rounded massaging surface and projecting a distance outwardly from the support,
wherein at least some of the massage elements project outwardly from the support by a first distance, and at least others of the massage elements project outwardly from the support by a second distance, whereby the first and second distances are different.

2. An orthopaedic device as claimed in claim 1, in which each massage element is shaped as a hemisphere.

3. An orthopaedic device as claimed in claim 1, in which the massage elements are hemispherical in shape, and a curved surface thereof provides the rounded massaging surface of each massage element.

4. (canceled)

5. An orthopaedic device as claimed claim 1, in which each massage element comprises a substantially flat base for engaging with the support and a curved surface operable as the rounded massaging surface.

6. (canceled)

7. An orthopaedic device as claimed in claim 1, in which the massage elements are arranged substantially adjacently and packed closely together on the support.

8. An orthopaedic device as claimed in claim 1, in which at least some of the massage elements project outwardly from the support by a third distance, whereby the first, second and third distances are different.

9. (canceled)

10. An orthopaedic device as claimed in claim 1, in which the first, second and third distances are each in the range of 2 mm to 20 mm.

11. An orthopaedic device as claimed in claim 1, in which the massage elements are arranged in rows on the support.

12. (canceled)

13. An orthopaedic device as claimed in claim 1, in which the massage elements are arranged in rows on the support, and a position of a massage element in a row is determined by the distance that the massage element projects from the support.

14. (canceled)

15. An orthopaedic device as claimed in claim 1, in which the support is substantially triangular in plan view.

16. An orthopaedic device as claimed in claim 1, in which the support comprises first and second support members, and each support member comprises a plurality of integrally formed outwardly projecting massage elements.

17. An orthopaedic device as claimed in claim 16, in which the support members are integrally formed.

18. An orthopaedic device as claimed in claim 16, in which the support members are separate members and connect via connection means to form the support.

19. An orthopaedic device as claimed in claim 16, in which one of the support members is softer relative to the other of the support members.

20. An orthopaedic device as claimed in claim 16, in which the massage elements formed on one of the support members are softer relative to the massage elements formed on the other of the support members.

21. An orthopaedic device as claimed in claim 1, in which the support is provided by a pad or a mat.

22. An orthopaedic device as claimed in claim 21, in which the pad or mat is releasably connectable to a neck supporting cradle.

23. An orthopaedic device as claimed in claim 21 22, in which the neck supporting cradle comprises a substantially U-shaped mounting surface for the pad and a pivot element.

24. (canceled)

25. (canceled)

26. An orthopaedic device as claimed in claim 1, in which the massage elements are made of a plastic or rubber material.

27. An orthopaedic device as claimed in claim 1, in which the support is made of a plastic or rubber material.

28. (canceled)
